(19) United States
(12) Patent Application Publication
(10) Pub. No.: US 2015/0158196 A1
(43) Pub. Date: Jun. 11, 2015

(54) Non-Linear Slotting Profiles for Pipe and Pipe Liners

(71) Applicants: Christopher Mark Hayden, Shelton, CT (US); Mark William Hayden, Monroe, CT (US)

(72) Inventors: Christopher Mark Hayden, Shelton, CT (US); Mark William Hayden, Monroe, CT (US)

(21) Appl. No.: 14/566,517

(22) Filed: Dec. 10, 2014

Related U.S. Application Data
(60) Provisional application No. 61/913,966, filed on Dec. 10, 2013.

(51) Int. Cl. B26F 1/00; F16L 9/00; E21B 17/18; B26F 1/26

(52) U.S. Cl. CPC B26F 1/0038; B26F 1/26; F16L 9/00; E21B 17/18

(57) ABSTRACT

A method of forming non-linear slots in pipe and the resulting slotted pipes are disclosed. The non-linear slots can be created using fluid jet, plasma, laser or any cutting method capable of producing a non-linear slot through the wall of a pipe. One embodiment includes interruptions in the slots to form ribs or structural connections between the pipe material along either side of a slot. The non-linear slots can be arranged in longitudinal, latitudinal, or in a helical orientation around the axis of the liner in straight, staggered, or ganged patterns. The slots can be formed in any non-linear shape, pattern, or slot thickness. One method employs high pressure fluid jet cutting from within the pipe, resulting in slots having a smaller width at the outside surface of the pipe.

### BACKGROUND

This invention relates to the field of slotted liners (pipes, casings)/screens used in Oil, Gas, and Irrigation industries (SAGD, CSS, Conventional Oil Wells, Fracking, CBM). More specifically this invention relates to the profile of the slots of the said liners, screens, and pipes mentioned above to enhance the efficiency and structural integrity of these components.

Slotted liners/screens can be defined by a regular pattern of slots with a specific phasing, width and length. The slotted liner have typically been machined by rotating saw blades creating multiple longitudinal slots, for example 0.012 in×2 in, spread across the length and circumference of each length of pipe. Slotted liners/screens are used to control the influx of sand/solids into production pipe and steam distribution in oil and gas wells.

Steam Assisted Gravity Drain (SAGD), cyclic steam stimulation (CSS) and steam flooding are common exploitation methods used as enhanced oil recovery techniques. SAGD is growing increasingly popular for thermal enhanced oil recovery in the oil sands. The SAGD process requires two horizontal wells to be drilled with one approximately 5 meters above the other. The top well or injection well continuously injects low pressure steam to heat the bitumen or heavy oil, heat reduces the oil viscosity which allows the oil to mobilize and flow to the bottom well were it is produced to surface along with the condensed water. The water is then separated from the oil, treated and reused to create additional steam. The continuous steam injection is designed to create a steam chamber that grows both vertically and horizontally in the reservoir. Present technologies include steam injection via low open area slotted liners, having approximately 1% open area. These methods are commonly used with sand control screens or liners to add radial resistance to steam flow and encourage axial distribution of the steam along the horizontal wellbore and promote equalized distribution. One issue with this technology is that the injection liner often has too large of an open area and therefore cannot provide sufficient radial resistance to steam flow. This leads to non-uniform steam distribution.

The open area of the injection liner is generally designed to provide a means for controlling and preventing sand from plugging pore spaces of the reservoir either directly or indirectly above the injection liner. It also acts to prevent sand from plugging the profile of the injection liner during the production phase oil recovery. The open area for sand control typically is 3%, but can range from 1.5%-5%. The required open area desired for equalized steam distribution, which is typically <0.05% but can range from 0.001%-1%. Slots cut in pipe used for oil and gas production typically have a straight line profile. This is due in part to the limitations of machine processes used to cut the slots.

Petroleum engineers have used hydraulic fracturing as a means of increasing well production since the late 1940's. Fractures can also exist naturally in formations, and both natural and man-made fractures can be widened by this process. As a result, more oil and gas can be extracted from a given area of land. Fracturing allows for extended production in older oil and natural gas fields. It also allows for the recovery of oil and natural gas from formations that geologists once believed were impossible to produce, such as tight shale formations. Hydraulic fracturing is also used to extend the life of older wells in mature oil and gas fields. Hydraulic fracturing is the propagation and expansion of fractures in a rock layer using pressurized fluid, typically a water-based solution. When man-made to release petroleum products and natural gas, the procedure is called fracking or hydro fracking. The energy from the injection of highly pressurized fracking fluid creates new channels in rock which increases the extraction rate and ultimate recovery of fossil fuels. The fracture width is typically maintained after injection by introduction of proppant into the injected fluid. Proppant is a material such as grains of sand, ceramic or other particulates that prevent the fractures from closing when the injection is stopped. The use of slotted casing has found to improve the filtering of particulates in horizontal well applications, but has been limited to perforated or linear slot profiles based on current machining technologies. The slots or perforations are usually larger than would be necessary to exclude particulates, which can lead to future clogging and increased wear on pumping equipment from abrasive particles in the recovered petroleum.

Casing and liner pipe must be connected to form an elongated string that is used to form a permanent down hole part of a producing well. Large torsion, compression and tension forces are imposed on pipe sections making up such strings during installation and retrieval, if necessary. Slotted casing and liner pipe must be capable of withstanding the forces imposed during installation and later during production. Horizontal wells in particular require pipe that can withstand significant compressive forces present in such installations. To prevent failure and/or damage to slotted casing, liners and screens, it is common to reduce the magnitude of force applied to slotted pipe during installation due to the inherently reduced strength of the slotted pipe relative to an un-slotted pipe. Ultimately slotted liner takes significantly longer to install then un-slotted liner.

### SUMMARY

The present invention overcomes the many obstacles of linear slotted pipe used for casing, liners, and screens by employing non-linear slotting patterns. Non-linear slotting patterns can optimize flow area and particulate exclusion while maintaining pipe structural integrity. A non-linear slotting method can provide slot profiles optimized for each particular geological formation to maximize efficiency of the specific project in which it is used (SAGD, CSS, Conventional, Fracking, CBM, Irrigation). Along with using non-linear profiles, the disclosed non-linear profiles can be structurally enhanced by adding stiffing ribs inside the slot to prevent it collapsing. The ribs are shown in FIG. 4 as interruptions in the slot where the materiel of the pipe is left intact to enhance the structural integrity of the slotted pipe. The non-linear slots can be arranged in longitudinal, latitudinal, or in a helical orientation around the axis of the liner in straight, staggered, or ganged patterns. These patterns can be arranged in any non-linear shape, pattern, or slot thickness. The process of creating the non-linear slots can be accomplished by ultra high pressure fluid cutting, plasma, laser, mill, saw, or any other equipment that can create a non-linear profile. FIGS. 3-7 illustrate various non-linear slot profiles that may be employed according to aspects of the invention. Combinations of different non-linear profiles may be combined, depending upon the specific geology and project parameters. It will be understood by those skilled in the art that the open area, flow characteristics and particle exclusion properties of pipe for a specific project will be dictated by the geology of the particular field, the recovery technique and the petroleum being recovered. Non-linear slot profiles provide additional flexibility in achieving the required flow and particle exclusion characteristics, while maintaining the structural integrity of the pipe.

FIG. 6 illustrates a comparison between a conventional slotted pipe having a linear slot pattern aligned with the length of the pipe and a pipe having a non-linear slot profile according to aspects of the present disclosure. Pipe having non-linear slot profiles providing greater flow area as the linear slot profiles are substantially stronger and result in less slot deformation when exposed to the same force. The linear slot profile pipe has a flow area of 0.037 in², while the non-linear slot profile pipe has a flow area of 0.054 in² and still displays significantly enhanced resistance to force applied to the pipe. This added strength could allow the use of pipe having a thinner wall or could permit enhanced flow area using the same pipe.

### BRIEF DESCRIPTION OF THE DRAWINGS

FIG. 1 is a diagram of one embodiment of a fluid jet cutting system having a fluid jet cutting assembly that includes cutters movable along a longitudinal axis for cutting slots in a hollow work piece

FIG. 2 is a perspective view of one embodiment of the fluid jet cutting assembly of FIG. 1

FIG. 3 illustrates one example of a non-linear slot profile.

FIG. 4 identifies structural ribs, or interruptions.

FIG. 5 identifies various patterns of non-linear slot profiles.

FIG. 6 identifies the profile design

FIG. 7 illustrates a plurality of various non-linear profiles.

FIG. 8 identifies FEA analysis performed on a standard slotted.

### DETAILED DESCRIPTION

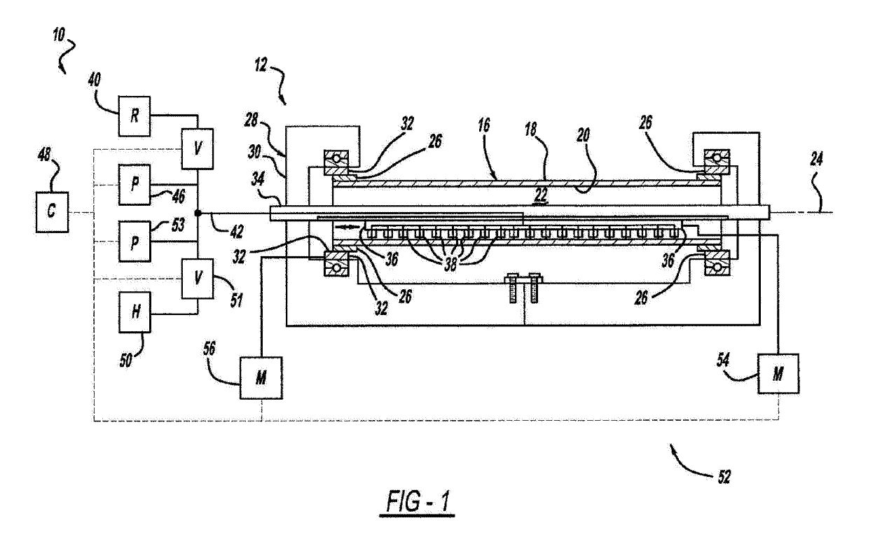

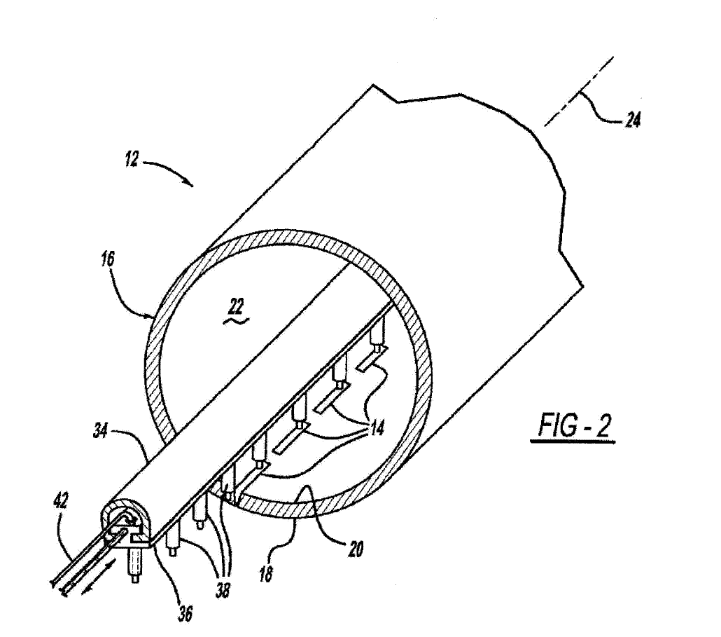

Referring to FIGS. 1 and 2, one embodiment of a fluid jet cutting system 10 (“system”) may have a fluid jet cutting assembly 12 (“assembly”) for cutting slots 14 (FIG. 2) in a hollow work piece 16 to produce, for example, a slotted liner for SAGD wells. The work piece 16 may be a casing or conduit having an outer surface 18 and an inner surface 20 that defines a passage 22 along a longitudinal axis 24.

The assembly 12 may have an attachment mechanism 26 for engaging and supporting the work piece 16. The attachment mechanism 26 may be a pair of clamps adapted to hold opposing ends of the work piece 16 or may be other suitable support in contact with any portion of the work piece 16.

The assembly 12 may also have a base 28 that may support the attachment mechanism 26. The base 28 in this form may include a body 30 and a mechanism 32 rotatable carried by the body 30. The mechanism 32 may be adapted to index or pivot the attachment mechanism 26 and work piece 16 in a rotational direction about the longitudinal axis 24. The rotary mechanism 32 may be a chuck, hub, friction rollers or any suitable rotary mechanism with ball bearings or other rotatable couplings. Furthermore, the base 28 may also have a shaft 34, which may extend from the body 30 and may be received within the passage 22 of the work piece 16.

The assembly 12 may also have a carrier 36 or carriage, which in this form may be supported by the shaft 34 for movement along the longitudinal axis 24. The carrier 36 in this form may be a bracket slidably carried by the shaft 34 by a tongue in groove attachment, bushing or other slidable couplings. Of course, the carrier 36 may be a plate, a shuttle or other carriers that may be slidably mounted to any portion of the base 28. Further, it is contemplated that the carrier 36 may instead be held in one fixed position on the shaft, which may in turn be slidably carried by the base.

As best shown in FIG. 2, the assembly 12 may also have an array of fluid jet cutters 38 that may be carried by the carrier 36. The cutters 38 may be disposed in the passage 22 of the work piece 16 for cutting the work piece 16 from its inner surface 20 to its outer surface 18. The cutters 38 in one form may be 18 to 24 conventional waterjet cutting nozzles or any number of suitable cutters. The cutters 38 may also be directed toward one radial direction from the longitudinal axis 24. For example, each cutter may be directed downward from the shaft 34. Furthermore, the cutters 38 may be arranged in a predetermined pattern with respect to each other by, for example, spacing them apart from each other by a generally uniform distance along the longitudinal axis 24. For example, the cutters 38 may be uniformly spaced 6 inches to 2 feet apart from each other along the longitudinal axis. Of course, the cutters may be uniformly spaced apart from each other by more or less than 6 inches to 2 feet or unevenly spaced apart from each other as dictated by design requirements of the work piece. This is duplicated from the opposite end of the work piece.

Referring to FIG. 1, the assembly 12 may also have a reservoir 40 for containing fluid, such as water, and a line 42 or conduit that may be communicated between the reservoir 40 and the cutters 38. The line 42 may include a valve 44, such as a solenoid valve, for selectively fluid from the reservoir 40 to the cutters 38. Further, the assembly 12 may include a pump 46 that may be connected to the line 42, such that the pump 46 may pump fluid from the reservoir 40 through the line 42 to the cutters 38 at a predetermined pressure. It is further contemplated that the assembly 12 may have an abrasive garnet hopper 50 or container, which may be used for storing an abrasive garnet. The hopper 50 may be communicated with a valve 51, which may in turn be communicated with the line 42. The assembly 12 may also have a pump 53 for pumping the abrasive garnet from the hopper 50 into the line 42.

The system 10 may also have a drive mechanism 52 that may engage the carrier 36 for movement along the longitudinal axis 24. The drive mechanism 52 in one form may be a CNC control system (“CNC system”). The CNC system may have a stepper motor 54 that engages the carrier 36 for moving the carrier 36 along the longitudinal axis 24. Of course, the CNC system may instead have a servo motor or other suitable motors. The CNC system may also include a controller 48 that may be operably associated with the motor 54 for generating a plurality of signals to induce the motor 54 to move the carrier 36 and cutters 38 thereon. In addition, the CNC system may include another motor 56 that engages the rotary mechanism 32 for indexing the rotary mechanism and the work piece 16 in the rotational direction. The controller 48 may be operably associated with the motor 56 and generate a plurality of signals to induce the motor 56 to rotate the mechanism 32 and work piece 16 to create the nonlinear slot patterns.

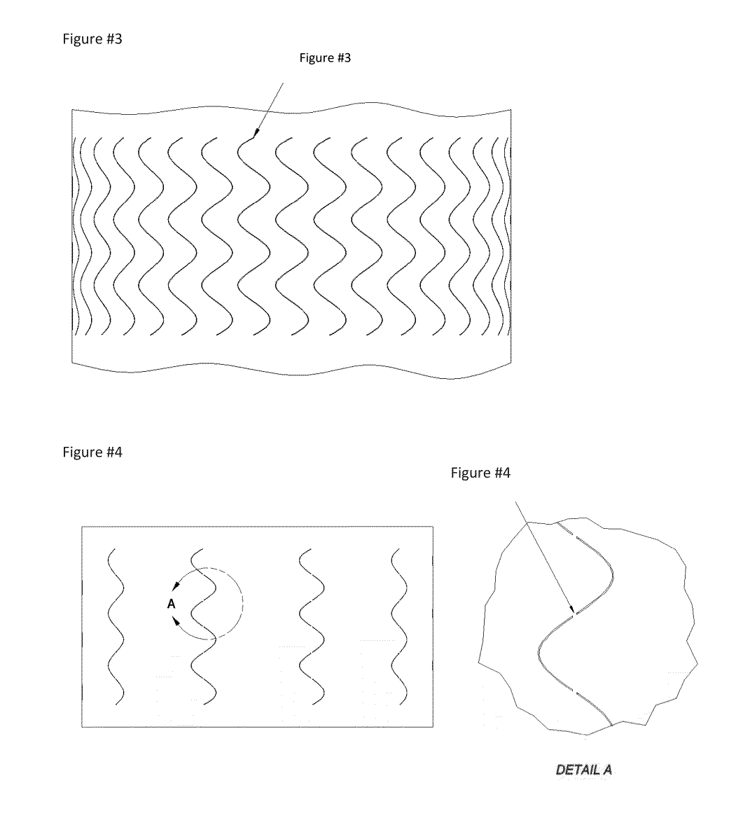

FIG. 3 illustrates one example of a non-linear slot profile. FIG. 4 identifies structural ribs, or interruptions in the illustrated non-linear slot to enhance the structural integrity of the slotted pipe. The slot width is a function of the design of the profile and is sized based on FEA analysis to optimize strength and efficiency.

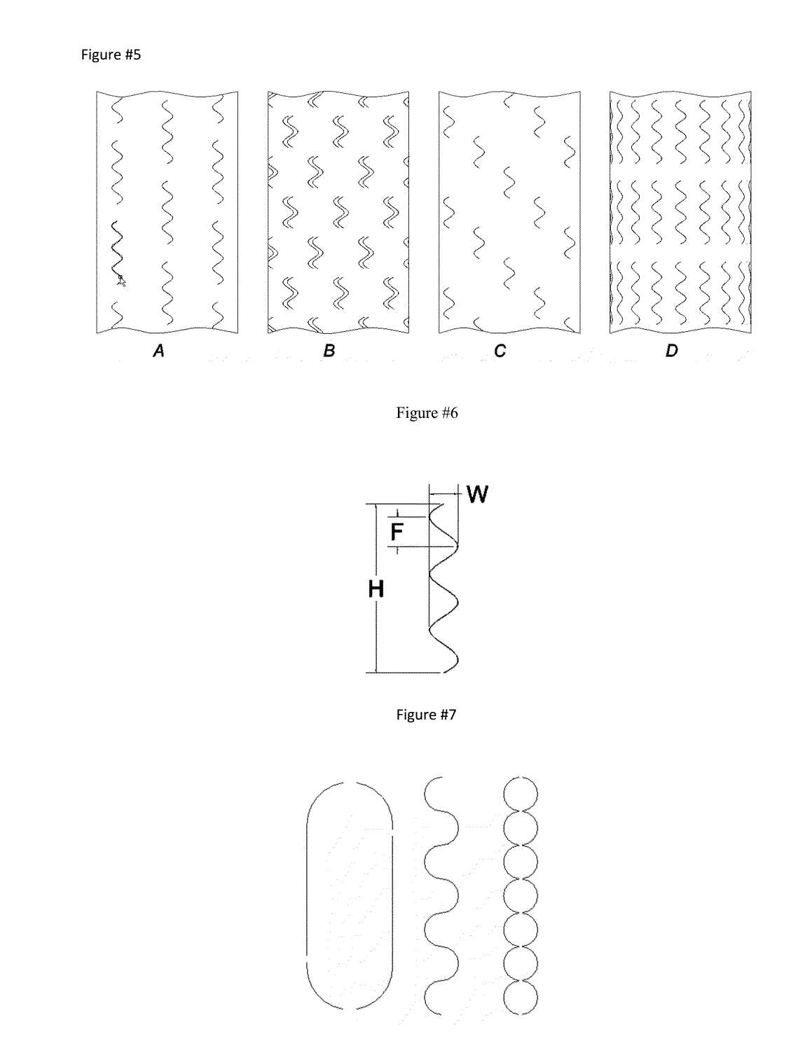

FIG. 5 identifies various patterns of non-linear slot profiles. Pattern “A” details a staggered pattern, pattern “B” details a gang pattern, pattern “C” is a helical pattern, and pattern “D” is a standard straight pattern. Infinite patterns are possible with various slot profiles, which are typically dependent upon the geological requirements of the specific well or field.

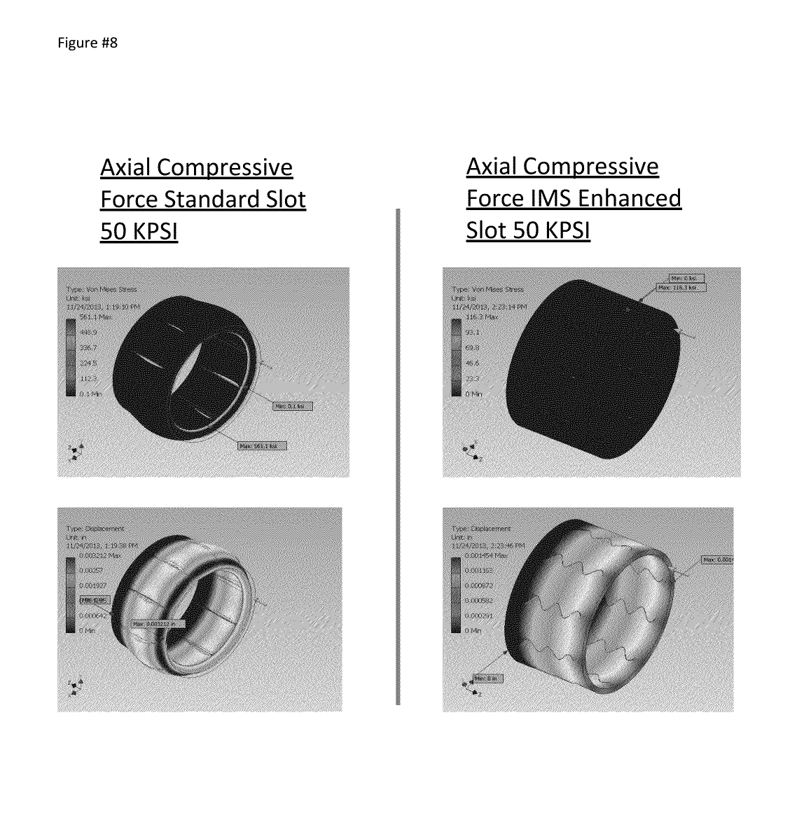

FIG. 6 identifies the profile design. This profile can be modified to accommodate geological requirements. “W” designates the slot profile width measured transverse to the pipe length, “H” designates the slot profile height along the pipe length, and “F” establishes the frequency or period of the repeating curve from which the non-linear slot profile is constructed.

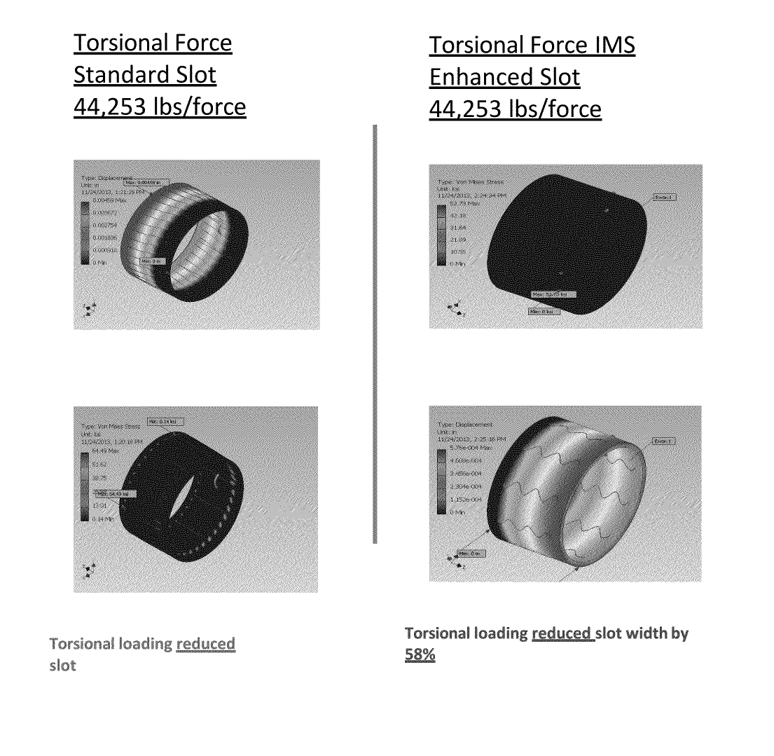

FIG. 7 illustrates a plurality of various non-linear profiles to enhance according to aspects of the disclosure.

FIG. 8 identifies FEA analysis performed on a standard slotted liner with linear slots parallel with the pipe length and a comparable pattern of non-linear slots according to the proposed invention. As seen in the illustrations the pipe having a nonlinear slot profile resists torsional and compressive forces well beyond a standard slotted liner having a linear slot profile.

What is claimed is:

1. A method of manufacturing a perforated pipe comprising:
arranging said pipe on a support, said pipe having a peripheral sidewall surrounding an interior space;
positioning a cutting head adjacent said pipe;
activating said cutting head to cut said pipe while causing relative movement between said cutting head and said pipe along two axes to produce elongated, non-linear openings through said peripheral sidewall.

2. The method of claim 1, wherein said step of positioning includes positioning said cutting head in said interior space prior to activating said cutting head.

3. The method of claim 1, wherein said step of positioning comprises positioning a plurality of cutting heads within said interior space and said step of activating comprises activating a plurality of said cutting heads to simultaneously cut said pipe.

4. The method of claim 1, wherein said step of positioning comprises positioning a fluid jet cutting head within said interior space.

5. The method of claim 1, comprising the step of interrupting said cutting while continuing said relative movement so that each said non-linear opening is interrupted at least once along a length of each non-linear opening.

6. A slotting geometry for a metal pipe having a tubular body having a first end, a second end, and a peripheral sidewall having slots arranged in a geometric pattern, the slots extending through the peripheral sidewall thereby permitting fluid communication from an exterior surface of the tubular body to an interior of the tubular body, the slotting geometry comprising:
each slot is non-linear and includes at least one curved portion.

7. The slotting geometry for a metal pipe of claim 6, wherein each said slot has a first transverse dimension at an interior of the tubular body that is greater than a second transverse dimension at the exterior surface of the tubular body.

8. The slotting geometry for a metal pipe of claim 6, wherein at least one of said slots is interrupted along its length, said interruptions forming structural ribs connecting the tubular body across said at least one slot.
